(19) United States
(12) Patent Application Publication
(10) Pub. No.: US 2020/0407245 A1
(43) Pub. Date: Dec. 31, 2020

(54) ELECTROCOAGULATION DEVICE

(71) Applicant: AMOGREENTECH CO., LTD., Gimpo-si (KR)

(72) Inventors: Jin LEE, Incheon (KR); Kyung Gu HAN, Goyang-si (KR)

(21) Appl. No.: 16/488,019

(22) PCT Filed: Mar. 7, 2018
(86) PCT No.: PCT/KR2018/002709

§ 371 Date: Aug. 22, 2019

(30) Foreign Application Priority Data
Mar. 8, 2017 (KR) 10-2017-0029647

(51) Int. Cl. C02F 1/463; C02F 1/461

(52) U.S. Cl. CPC C02F 1/463; C02F 1/46109; C02F 2103/001; C02F 2201/4613; C02F 2201/4619; C02F 2001/46133

(57) ABSTRACT

Provided is an electrocoagulation device. The electrocoagulation device includes: a housing having an inner space with an open top; and an electrode part which is disposed in the inner space and in which a plurality of electrode plates are disposed spaced apart from one another at intervals so that pollutants contained in raw water supplied from the outside can be coagulated using the principles of electrocoagulation, wherein the inner space includes: a first chamber into which the raw water is introduced; a second chamber which is formed above the first chamber and in which the electrode part is disposed; and a third chamber which temporarily stores treated water that has completed an electrocoagulation reaction in the second chamber.

### TECHNICAL FIELD

The present invention relates to a pollutant treatment device for water treatment, and more specifically, to an electrocoagulation device configured to effectively remove pollutants contained in raw water using the electrocoagulation principle.

### BACKGROUND ART

Water pollution due to nitrate is caused by industrial wastewater and excessive use of chemical fertilizers in agricultural areas. When nitrogen-containing compounds are introduced into water, water quality degradation such as eutrophication occurs in the water. In addition, when a person ingests the water containing the nitrogen-containing compounds, the nitrogen-containing compounds can cause health disturbances such as cancer, cyanosis, and the like.

Nowadays, methods for removing nitrate from wastewater include an ion exchange resin method, a biodegradation method, a reverse osmosis method, electrodialysis method and a catalyst denitrification method. The ion exchange resin method has a process which is useful for treating groundwater but leaves a number of residual components which are unnecessary in treated water, and the biodegradation method has a process which is useful for treating surface water but has a disadvantage in that a long treatment time period is generally required. In addition, the method using reverse osmosis or electrodialysis can achieve a nitrate removal efficiency of about 65% but has a disadvantage in that a cost of energy input is high.

Accordingly, an electrocoagulation method through which an amount of an applying current is adjusted to provide an exact amount of coagulating agent, automation is facilitated, energy consumption is low, and pollutants are destabilized, coagulated, and separated using one process has been in the spotlight.

The electrocoagulation method is a method through which metal ions are eluted from an electrode plate when a current is provided thereto, the eluted metal ions are adsorbed onto and coagulated to the pollutants in wastewater so that the pollutants float or are precipitated by hydrogen and chlorine gas.

However, since the conventional electrocoagulation method is a method through which water to be treated passes among a plurality of electrodes which are simply disposed, the method has a problem in that water treatment efficiency is low.

### DISCLOSURE

### Technical Problem

The present invention is directed to providing an electrocoagulation device in which water to be treated is uniformly introduced onto a plurality of electrode plates.

In addition, the present invention is directed to providing an electrocoagulation device in which a replacement time period of an electrode plate is prolonged to decrease a maintenance cost.

### Technical Solution

One aspect of the present invention provides an electrocoagulation device including a housing having an inner space with an open upper portion, and an electrode part which is disposed in the inner space and in which a plurality of electrode plates are disposed to be spaced apart from each other at intervals to coagulate pollutants contained in raw water supplied from the outside using an electrocoagulation principle, wherein the inner space includes a first chamber into which the raw water is introduced, a second chamber which is formed above the first chamber and in which the electrode part is disposed, and a third chamber which temporarily stores treated water of which an electrocoagulation reaction is completed in the second chamber.

The plurality of electrode plates may include a pair of power electrodes to which power supplied from the outside is applied, and a plurality of sacrificial electrodes which are disposed in parallel between the pair of power electrodes to be spaced apart from each other at predetermined intervals.

Insertion grooves may be formed inward from an inner wall of the housing, which defines the second chamber, in a height direction to fix positions of the power electrodes and the sacrificial electrodes.

Another aspect of the present invention provides an electrocoagulation device further including an electrode case to which the power electrodes and the sacrificial electrodes are detachably coupled to be attachable or detachable, wherein insertion grooves may be formed inward from an inner wall of the electrode case in a height direction to fix positions of the power electrodes and sacrificial electrodes, and the electrode case may be coupled to the second chamber of the housing. In this case, the electrode case may be formed of an insulating material or non-conductive material.

An inlet pipe which has a predetermined length and in which a plurality of injection holes are formed may be disposed in the first chamber, wherein the inlet pipe may be disposed in a direction parallel to a direction in which the electrode plates are arranged.

A diffuser which has a predetermined length and in which a plurality of outlet holes are formed may be disposed in the first chamber, wherein the diffuser may spout bubbles through the outlet holes using air supplied from the outside.

The second chamber and the third chamber may be partitioned by a partition which protrudes to a predetermined height in the inner space, and treated water of which an electrocoagulation reaction is completed in the second chamber may pass over an upper end of the partition and move to the third chamber.

At least one outlet hole may be formed in a bottom surface of the third chamber to discharge the treated water to the outside.

The housing may be formed of an insulating material or non-conductive material.

An outer surface of the housing may be coated with a coating layer having at least one among chemical resistance, corrosion resistance, and electrical insulation property.

The electrocoagulation device may further include a control part configured to control power to be supplied to the electrode part, wherein the control part may periodically change poles of the power applied to the electrode part.

The plurality of electrode plates may be formed of any one among iron, aluminum, stainless steel, and titanium.

### Advantageous Effects

According to the present invention, since water to be treated simultaneously comes into contact with the same areas of a plurality of electrode plates while an uniform water level of the water to be treated is maintained, an overall treatment speed can be high.

In addition, since contamination and/or damage of the electrode plates can be prevented or foreign matter adsorbed onto the electrode plates can be removed by supplying bubbles generated by a diffuser to water to be treated while the water to be treated is treated, a maintenance cost can be reduced.

### DESCRIPTION OF DRAWINGS

FIG. 1 is a schematic view illustrating an electrocoagulation device according to one embodiment of the present invention.

FIG. 2 is a view illustrating main components of FIG. 1.

FIG. 3 is a partially cut-away view illustrating an internal structure of a housing of FIG. 2.

FIG. 4 is a cross-sectional view of FIG. 2.

FIG. 5 is a schematic view illustrating a case in which a diffuser is included in FIG. 2.

FIG. 6 is a cross-sectional view of FIG. 5.

FIG. 7 is a schematic view illustrating an inlet pipe and the diffuser which are applicable to the electrocoagulation device according to one embodiment of the present invention.

FIG. 8 is a view illustrating main components of an electrocoagulation device according to another embodiment of the present invention.

FIG. 9 is an exploded view of FIG. 8.

FIG. 10 is a bottom view illustrating an electrode case which is applicable to FIG. 8.

FIG. 11 is a schematic view illustrating an electrocoagulation system to which the electrocoagulation device according to one embodiment of the present invention is applied.

### MODES OF THE INVENTION

Hereinafter, embodiments of the present invention will be described in detail with reference to the accompanying drawings in order for those skilled in the art to easily perform the present invention. The present invention may be implemented in several different forms and is not limited to the embodiments described herein. Parts irrelevant to description are omitted in the drawings in order to clearly explain the present invention. In addition, components which are the same or similar to each other are assigned to the same reference numerals.

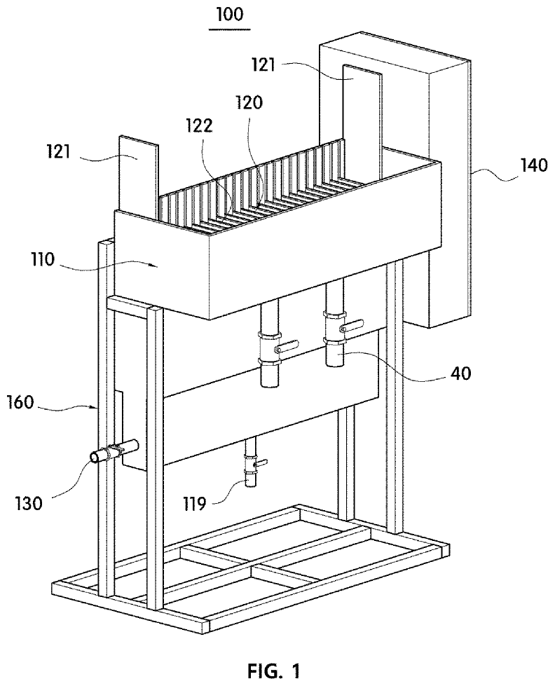

As illustrated in FIGS. 1, 5, and 8, an electrocoagulation device 100, 100′, or 200 according to one embodiment of the present invention includes a housing 110 or 210 and an electrode part 120.

The housing 110 or 210 may provide a space for temporarily storing raw water supplied from the outside. To this end, the housing 110 or 210 may be formed in a box form having an inner space with an upper portion open.

That is, the inner space which is a staying space of the raw water may be formed in the housing 110 or 210, and the inner space may be the staying space from which the raw water introduced from the outside is transferred to a separate treatment space after pollutants contained in the raw water are coagulated according to the electrocoagulation principle.

To this end, the inner space may include a first chamber 111 into which the raw water is introduced, a second chamber 112 in which the electrode part 120 is disposed, and a third chamber 113 which temporarily stores the treated water of which an electrocoagulation reaction is completed in the second chamber 112.

In this case, the second chamber 112 in which the electrode part 120 is disposed may be formed above the first chamber 111, and the third chamber 113 may be formed side by side of the first chamber 111. In addition, the second chamber 112 and the third chamber 113 which are disposed side by side with each other may be partitioned by a partition 114 which is formed to protrude to a predetermined height in the inner space.

Accordingly, the first chamber 111 may serve as a buffer space in which raw water supplied from the outside is accommodated before moving to the second chamber 112 in which an electrocoagulation reaction is performed, and the raw water introduced into the first chamber 111 may be transferred to the second chamber 112 while maintaining a uniform water level. Accordingly, the raw water introduced into the second chamber 112 simultaneously comes into contact with the same areas of a plurality of electrode plates 121 or 122 forming the electrode part 120, and thus an overall treatment speed can be faster.

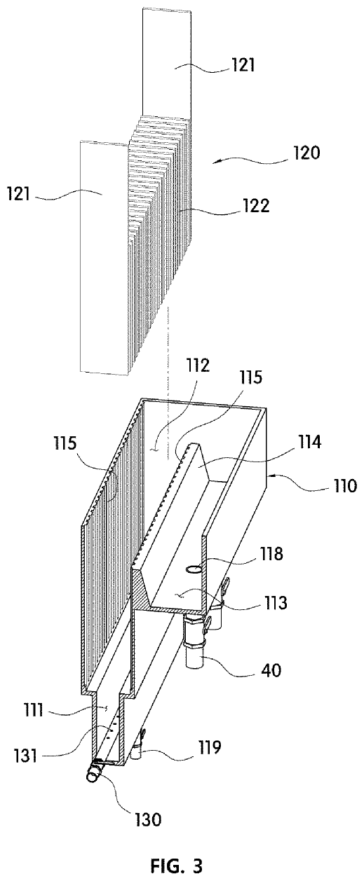

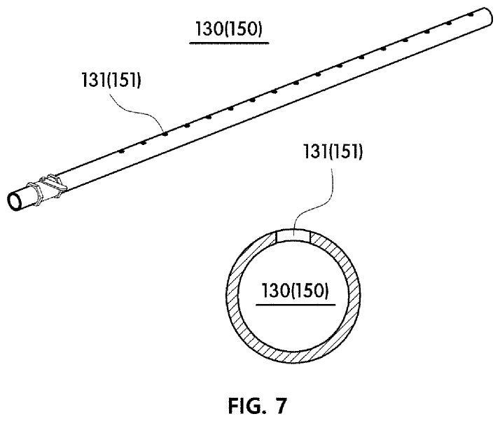

Here, an inlet pipe 130 having a predetermined length and a hollow shape and including a plurality of injection holes 131 which are formed in a length direction may be disposed in the first chamber 111. Through this, raw water supplied to the inlet pipe 130 from the outside may be spouted to the first chamber 111 through the injection holes 131 (see FIGS. 3 and 7). In this case, the inlet pipe 130 may be disposed in a direction parallel to a direction in which the plurality of electrode plates 121 or 122 forming the electrode part 120 are disposed. In addition, a drain outlet hole 118 connected to a drain pipe 119 may be formed in a bottom surface of the first chamber 111 to discharge treated water to the outside.

As described above, a water level of the raw water in the electrocoagulation device 100, 100′, or 200 according to one embodiment of the present invention may be gradually raised after the raw water sprayed from the injection holes 131 of the inlet pipe 130 is completely filled in the first chamber 111. Accordingly, the raw water may move to the second chamber 112 from the first chamber 111 while the water level is uniformly maintained. Then, after a coagulating reaction is completely performed in the raw water introduced into the second chamber 112 through the electrode part 120, the raw water may pass over an upper end of the partition 114 from the second chamber 112 and be introduced into the third chamber 113.

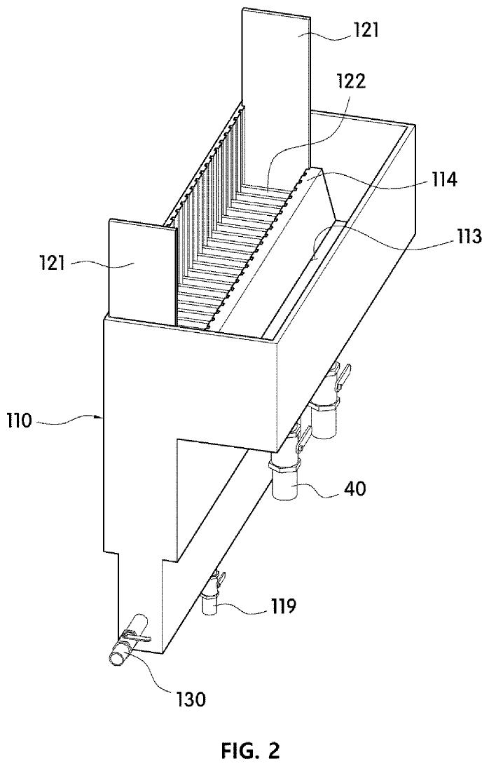

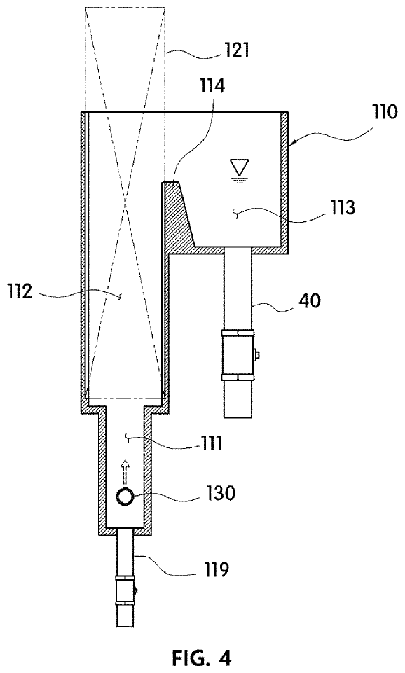

In this case, one surface, which forms a wall surface of the third chamber 113, of the partition 114, may be formed to be an inclined surface. As an example, the inclined surface may be inclined downward toward the third chamber 113 from an upper end to a lower side of the partition 114 (see FIGS. 2 to 4). Accordingly, treated water which overflows over the upper end of the partition 114 may smoothly move to the third chamber 113 along the inclined surface.

In addition, at least one outlet hole 118 may be formed in the bottom surface of the third chamber 113. Since the outlet hole 118 is connected to a post-processing device, which treats pollutants coagulated through an electrocoagulation reaction, through a separate pipe 40, water to be treated may be transferred to the post-processing device.

Meanwhile, the housing 110 or 210 may be formed of an insulating material or non-conductive material to prevent a short circuit with the electrode part 120 disposed in the second chamber 112 when power is applied. As an example, the housing 110 or 210 may be formed of a material such as plastic, concrete, and plywood but is not limited thereto, and any well-known insulating material or non-conductive material may be used as a material of the housing 110 or 210.

In addition, a coating layer having at least one property among chemical resistance, corrosion resistance, and electrical insulation property may be formed on an outer surface of the housing 110 or 210. Through this, damage of the surface of the housing 110 or 210 due to heavy metals contained in raw water may be prevented.

The housing 110 or 210 may be fixed using separate support frames 160, and in a case in which the housing 110 or 210 includes the support frames 160, a control part 140 to be described later may also be fixed to one side of the support frame 160.

The electrode part 120 may elute metal ions during an electrolysis process when power is applied. Accordingly, since the metal ions are coagulated to and adsorbed onto pollutants contained in raw water, pollutants may be coagulated into flocs having lump forms.

That is, when a predetermined voltage is applied to sacrificial electrodes 122, a metal may be dissolved from the electrode plate so that hydroxides may be generated in the electrode part 120. In addition, since the hydroxides generated through the above-described process are coagulated with colloidal materials and the like contained in raw water and precipitated in the raw water, pollutants contained in the raw water may be electrically neutralized with positive metal ions eluted from the electrode plate due to electrical energy. Through this, since a coagulate reaction, an oxidation reaction, and a reduction reaction simultaneously occur in the pollutants, the pollutants can be removed from the raw water.

As an example, in a case in which the electrode plate forming the electrode part 120 is formed of iron, pollutants may be formed into polymer hydroxide flocs through the following reaction.

[Mechanism 1]

<Positive Electrode Reaction>

Fe_{(solid)}→Fe²⁺_{(aqueous solution)}+2e⁻

Fe²⁺_{(aqueous solution)}+2OH⁻_{(aqueous solution)}→Fe(OH)_{2(solid)}

<Negative Electrode Reaction>

2H₂O_{(liquid)}+2e⁻→H_{2(gas)}+2OH⁻_{(aqueous solution)}

<Overall Reaction>

Fe_{(solid)}+2H₂O_{(liquid)}→Fe(OH)_{2(solid)}+H_{2(gas)}

<Oxidation Reaction>

2Cl⁻→Cl₂+2e⁻

Cl_{2(gas)}+H₂O→HOCl+H⁺+Cl⁻

Fe(OH)₂+HOCl→Fe(OH)_{3(solid)}+Cl⁻

[Mechanism 2]

<Positive Electrode Reaction>

4Fe_{(solid)}→4Fe²⁺_{(aqueous solution)}+8ₑ⁻

4Fe²⁺_{(aqueous solution)}+10H₂O_{(liquid)}+O_{2(gas)}→4Fe(OH)_{3(solid)}+8H⁺_{(aqueous solution)}

<Negative Electrode Reaction>

8H⁺_{(aqueous solution)}+8e⁻→4H_{2(gas)}

<Overall Reaction>

4Fe_{(solid)}+10H₂O_{(liquid)}→4Fe(OH)_{3(solid)}+4H_{2(gas)}

That is, ferrous iron (Fe²⁺) may be eluted into a solution and then oxidized into ferric iron (Fe³⁺) by a hypochlorous acid produced by dissolved oxygen and chlorine oxidation, and positive ions of Fe²⁺ may be hydrolyzed in water and adsorb nitrate to produce amorphous polymer hydroxide flocs and precipitated while satisfying a reaction formula of nFe(OH)_{3(solid)}+NO³⁻_{(aqueous solution)}→[Feₙ(OH)₃ₙ.NO³⁻]_{(solid)}. Through this, the produced hydroxide flocs may be collected by hydrogen gas and float due to buoyancy thereof, and thus NO³⁻ may be removed from a surface of raw water. Since the electrocoagulation principle is a well-known principle, a detailed description thereof will be omitted.

To this end, the electrode part 120 may include a plurality of electrode plates each having a plate shape and a predetermined area, and the plurality of electrode plates 121 or 122 may be disposed to be spaced apart from each other at predetermined intervals in the second chamber 112. As an example, the plurality of electrode plates 121 or 122 may include a pair of power electrodes 121 to which power supplied from the outside is applied and the plurality of sacrificial electrodes 122 which are disposed between the pair of power electrodes 121 and disposed in parallel to be spaced apart from each other at predetermined intervals such that one surfaces thereof face each other.

Here, the total number of sacrificial electrodes 122 and the intervals between the sacrificial electrodes 122 disposed between the pair of power electrodes 121 may be suitably changed according to a total treating capacity of raw water. In addition, the plurality of power electrodes 121, such as two or more thereof, may be provided, and the total number of sacrificial electrodes 122 and the intervals between the sacrificial electrodes 122 disposed between the power electrodes 121 may also be suitably changed.

In addition, the pair of power electrodes 121 may have lengths greater than those of the sacrificial electrodes 122 to easily apply power supplied from the outside. Through this, the pair of power electrodes 121 disposed at both sides of the second chamber 112 may be not completely submerged in raw water stored in the second chamber 112 and at least portions thereof may be exposed to the outside from a surface of the raw water (see FIG. 3).

On the other hands, the plurality of sacrificial electrodes 122 may be disposed to be completely submerged in the raw water stored in the second chamber 112. Through this, since a total area of the plurality of sacrificial electrodes 122 may directly come into contact with the raw water, a reaction area can be increased.

In this case, as the above-described, the plurality of electrode plates may be formed of any one among iron, aluminum, stainless steel, and titanium such that metal ions can be eluted when power is applied thereto. However, the material of the electrode plate is not limited thereto, and any well-known material used for an electrode may be used for the electrode plate.

Meanwhile, the plurality of electrode plates 121 or 122 forming the electrode part 120 may be directly fixed to the housing 110 or fixed to a separate member and then the separate member may be coupled to the second chamber 112.

As an example, as illustrated in FIGS. 1 to 3, the plurality of electrode plates 121 or 122 may be directly fixed to an inner wall of the housing 110. In this case, a plurality of insertion grooves 115 may be formed inward from the inner wall of the housing 110 which define the second chamber 112, more specifically, in an inner surface of the partition 114 and an inner surface of the housing 110 which face each other, and the number of plurality of insertion grooves 115 may correspond to the number of plurality of electrode plates 121 or 122.

Here, since upper ends of the insertion grooves 115 are open and lower ends thereof are sealed, insertion depths of lower ends of the electrode plates 121 or 122 can be limited.

Accordingly, when the plurality of electrode plates 121 or 122 are inserted into the insertion grooves 115, the electrode plates 121 or 122 may be disposed in parallel in a state in which the adjacent electrode plates 121 or 122 are spaced a predetermined distance from each other and one surfaces thereof face each other.

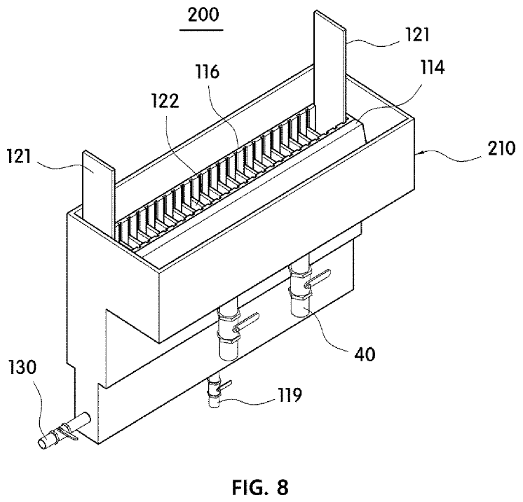

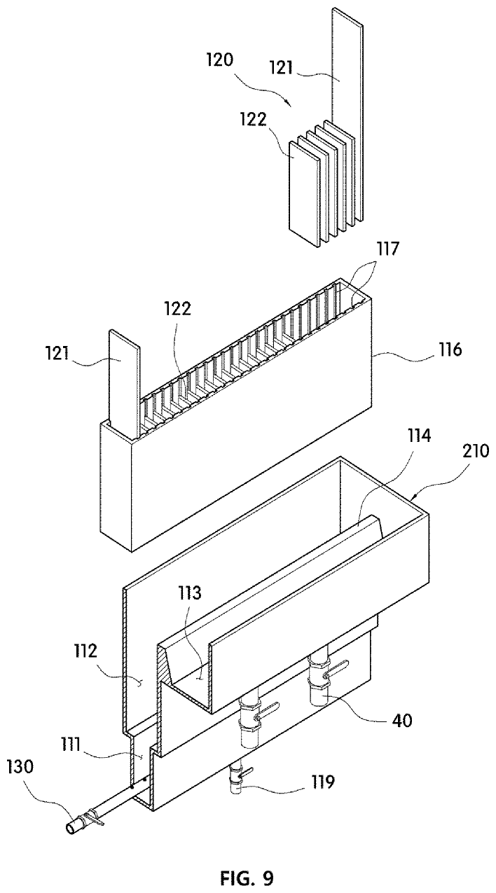

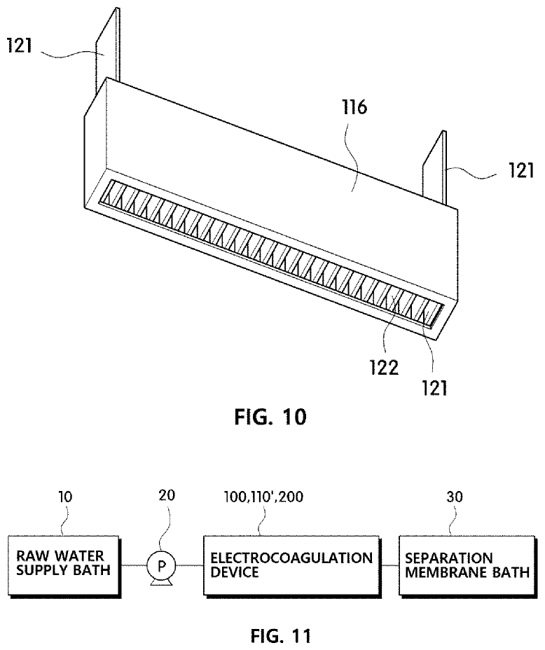

As another example, as illustrated in FIGS. 8 to 10, the plurality of electrode plates 121 or 122 may be fixed to an electrode case 116, and the electrode case 116 may be coupled to the second chamber 112 of the housing 210.

In this case, a plurality of insertion grooves 117 may be formed inward from inner walls, which face each other, of the electrode case 116 in a height direction of the electrode case 116, and the electrode case 116 may have a box form having open upper and lower portions.

Accordingly, in a state in which each of the plurality of electrode plates 121 or 122 is inserted into each of the insertion grooves 117, the electrode case 116 is inserted into the second chamber 112, and raw water, which moves upward, may be smoothly introduced from the first chamber 111 through the open lower portion.

In this case, the electrode case 116 may be formed of an insulating material or non-conductive material to prevent a short circuit with the electrode plates 121 or 122 inserted into the insertion grooves 117 when power is applied. As an example, the electrode case 116 may be formed of a material such as plastic, concrete, and plywood, but is not limited thereto, and any well-known insulating material or non-conductive material may be used as the material of the electrode case 116.

In addition, a coating layer having at least one property among chemical resistance, corrosion resistance, and electrical insulation property may be formed on an outer surface of the electrode case 116. Through this, damage of a surface of the electrode case 116 due to heavy metals contained in raw water may be prevented when the electrode case 116 comes in contact with the raw water.

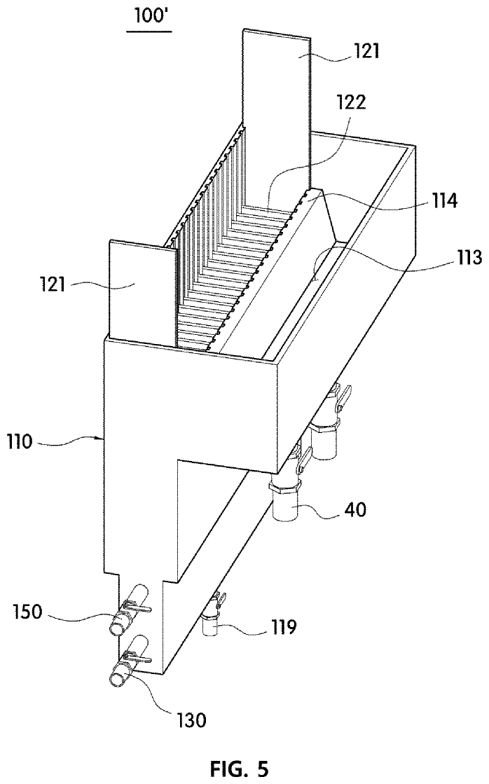

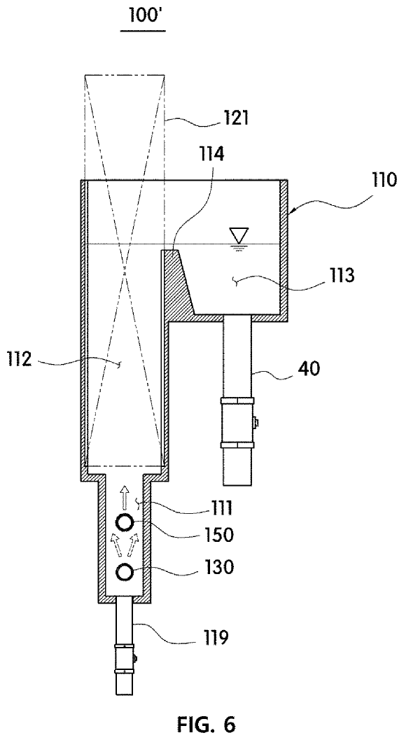

Meanwhile, as illustrated in FIGS. 5 and 6, the electrocoagulation device 100′ according to one embodiment of the present invention may include a diffuser 150 for generating bubbles.

The diffuser 150 may be disposed in the first chamber 111 formed under the second chamber 112. Accordingly, the diffuser 150 may generate bubbles in a process in which air supplied from the outside is spouted, and the bubbles may pass between the electrode plates 121 or 122 disposed in the second chamber 112.

Through this, when the electrocoagulation device 100′ is operated, the bubbles may prevent coagulated flocs, such as polymer hydroxide flocs generated due to an electrocoagulation reaction, from being adhered to the electrode plates 121 or 122. Accordingly, the polymer hydroxide flocs adhering to surfaces of the electrode plates 121 or 122 and polluting the surfaces may be minimized. In addition, when the electrocoagulation device 100′ is operated, since the bubbles can remove the coagulated flocs adhered to the electrode plates 121 or 122 through the ejection pressure, a usage time of the electrode plate 121 or 122 can be increased, and constant treatment performance can be maintained.

As an example, as illustrated in FIG. 7, the diffuser 150 may be a hollow pipe which has a predetermined length and in which a plurality of outlet holes 151 are formed in a longitudinal direction to pass through the diffuser 150, and the diffuser 150 may be disposed parallel to the inlet pipe 130 disposed in the first chamber 111. Here, the diffuser 150 may be disposed at the same height as the inlet pipe 130 or may also be disposed above or under the inlet pipe 130.

In this case, diameters of the outlet holes 151 of the diffuser 150 may range from 0.1 to 10 mm to generate bubbles having proper sizes. In addition, distances between the diffuser 150 and both of the power electrodes 121 and the sacrificial electrodes 122 may range from 5 to 100 mm and may preferably range from 20 to 30 mm. However, the distances between the diffuser and both of the power electrodes and the sacrificial electrodes are not limited thereto and may be suitably changed according to a total treating capacity of raw water.

When the electrocoagulation device 100′ is operated, the diffuser 150 may generate the bubbles, or the diffuser 150 may in a state in which the electrocoagulation device 100′ is not operated so that a cleaning task for quickly removing coagulated flocs, which adhere to the electrode plates 121 or 122, may be performed using the bubbles.

Meanwhile, the electrocoagulation device 100, 100′, or 200 according to one embodiment of the present invention may include a control part 140 for controlling an overall operation of the electrocoagulation device 100, 100′, or 200 such as power supply, power blocking, and an amount of power or a current density supplied to the power electrodes 121.

In this case, the control part 140 may periodically change poles of power applied to the pair of power electrodes 121. Through this, in the electrocoagulation device 100, 100′, or 200, since the poles of power applied to both surfaces of the electrode plates 121 or 122 are periodically changed during an electrocoagulation reaction, both surfaces of the electrode plates 121 or 122 may be evenly used, and thus replacement periods of the electrode plates 121 or 122 can be lengthened.

The above-described electrocoagulation device 100, 100′, or 200 according to one embodiment of the present invention may be applied to a pollutant removing system configured to coagulate pollutants contained in raw water using the electrocoagulation principle and filter coagulated flocs.

As an example, as illustrated in FIG. 11, the electrocoagulation device 100, 100′, or 200 according to one embodiment of the present invention may be disposed between a raw water supply bath 10 which supplies raw water such as sewage or wastewater, which should be treated, and a separation membrane bath 30 which filters coagulated flocs to configure the pollutant removing system.

In this case, the separation membrane bath 30 in which at least one filter member is disposed may be a well-known filtering apparatus for removing coagulated flocs generated in the electrocoagulation device 100, 100′, or 200 from raw water. In addition, a pump 20 may also be connected to a front end of the electrocoagulation device 100, 100′, or 200 so as to easily transfer the raw water from the raw water supply bath 10 to the first chamber 111 of the electrocoagulation device 100, 100′, or 200.

Accordingly, in the pollutant removing system, since pollutants contained in the raw water can be coagulated while the raw water provided from the raw water supply bath 10 passes through the electrocoagulation device 100, 100′, or 200 due to the electrocoagulation principle, and the coagulated pollutants in the electrocoagulation device 100, 100′, or 200 can be removed in the separation membrane bath 30, high filtering efficiency can be achieved in the separation membrane bath 30.

However, an overall configuration of the pollutant removing system is not limited thereto and may also include additional apparatuses such as a precipitation tank, a sludge thickening tank, a dehydration tank, and a reverse osmosis apparatus which are well-known apparatuses that are included in a general water treatment system.

While the embodiments of the present invention have been described above, the spirit of the present invention is not limited to the embodiment proposed in this specification, it will be understood by those skilled in the art that other embodiments may be easily suggested by adding, changing, and deleting components, and the other embodiments will fall within the spiritual range of the present invention.

1. An electro coagulation device comprising:
a housing including an inner space with an open upper portion; and
an electrode part which is disposed in the inner space and in which a plurality of electrode plates are disposed to be spaced apart from each other at intervals to coagulate pollutants contained in raw water supplied from the outside using an electrocoagulation principle,
wherein the inner space includes a first chamber into which the raw water is introduced, a second chamber which is formed above the first chamber and in which the electrode part is disposed, and a third chamber which temporarily stores treated water of which an electrocoagulation reaction is completed in the second chamber.

2. The electrocoagulation device of claim 1, wherein the plurality of electrode plates include:
a pair of power electrodes to which power supplied from the outside is applied; and
a plurality of sacrificial electrodes which are disposed in parallel between the pair of power electrodes to be spaced apart from each other at predetermined intervals.

3. The electrocoagulation device of claim 2, wherein insertion grooves are formed inward from an inner wall of the housing, which defines the second chamber, in a height direction to fix positions of the power electrodes and the sacrificial electrodes.

4. The electrocoagulation device of claim 2, further comprising an electrode case to which the power electrodes and the sacrificial electrodes are coupled to be attachable or detachable,
wherein insertion grooves are formed inward from an inner wall of the electrode case in a height direction to fix positions of the power electrodes and sacrificial electrodes, and the electrode case is coupled to the second chamber of the housing.

5. The electrocoagulation device of claim 1, wherein an inlet pipe which has a predetermined length and in which a plurality of injection holes are formed is disposed in the first chamber,
wherein the inlet pipe is disposed in a direction parallel to a direction in which the electrode plates are arranged.

6. The electrocoagulation device of claim 1, wherein a diffuser which has a predetermined length and in which a plurality of outlet holes are formed is disposed in the first chamber,
wherein the diffuser spouts bubbles through the outlet holes using air supplied from the outside.

7. The electrocoagulation device of claim 1, wherein:
the second chamber and the third chamber are partitioned by a partition which protrudes to a predetermined height in the inner space; and
treated water of which an electrocoagulation reaction is completed in the second chamber passes over an upper end of the partition and moves to the third chamber.

8. The electrocoagulation device of claim 1, wherein at least one outlet hole is formed in a bottom surface of the third chamber to discharge the treated water to the outside.

9. The electrocoagulation device of claim 1, wherein the housing is formed of an insulating material or non-conductive material.

10. The electrocoagulation device of claim 9, wherein an outer surface of the housing is coated with a coating layer having at least one among chemical resistance, corrosion resistance, and electrical insulation property.

11. The electrocoagulation device of claim 1, further comprising a control part configured to control power to be supplied to the electrode part,
wherein the control part periodically changes poles of the power applied to the electrode part.

12. The electrocoagulation device of claim 1, wherein the plurality of electrode plates are formed of any one among iron, aluminum, stainless steel, and titanium.
